(19) United States
(12) Patent Application Publication
(10) Pub. No.: US 2005/0209449 A1
(43) Pub. Date: Sep. 22, 2005

(54) Depolymerization of water soluble polysaccharides

(75) Inventor: Paulus Pieter De Wit, Westervoort (NL)

Correspondence Address: OLIFF & BERRIDGE, PLC, P.O. BOX 19928, ALEXANDRIA, VA, 22320, US

(73) Assignee: AKZO NOBEL N.V., BM Arnhem (NL)

(21) Appl. No.: 10/519,939

(22) PCT Filed: Jul. 7, 2003
(86) PCT No.: PCT/EP03/07327

§ 371 Date: Jan. 25, 2005

(30) Foreign Application Priority Data
Jul. 10, 2002 (EP) 02077756.1

(51) Int. Cl. C08B 11/20

(52) U.S. Cl. 536/88

(57) ABSTRACT

Process for preparing a solution of a polysaccharide or polysaccharide ether having a viscosity of 1,000 mPa·s or less comprising adding to an aqueous medium a polysaccharide or polysaccharide ether and an alkaline depolymerization agent. Also disclosed is a solid composition comprising a polysaccharide ether and an alkaline depolymerization agent. Preferably, the depolymerization agent is selected from the group consisting of sodium percarbonate, sodium perborate, carbamide peroxide in combination with a base, sodium persulfate in combination with a base, 3-chloroperoxybenzoic acid in combination with a base, and mixtures thereof.

The present invention relates to a process for preparing a solution of a polysaccharide or polysaccharide ether having a viscosity of 1,000 mPa·s or less and to a solid composition comprising a polysaccharide ether.

Low molecular weight, water soluble polysaccharides, in particular water soluble polysaccharide ethers such as sodium carboxymethyl cellulose, often referred to as carboxymethyl cellulose, are used in various applications, for example, in the paper making industry and in froth flotation for mineral separation. For paper applications, especially in the tissue industry, there is a need for low viscous carboxymethyl cellulose-containing formulations having a high solids content. Such formulations can only be prepared from low molecular weight water soluble polysaccharides or polysaccharide ethers. Froth flotation is the commonly used process for mineral upgrading separating precious metals from useless gangue minerals. Low molecular weight polysaccharides and polysaccharide ethers, such as low viscous carboxymethyl cellulose, are considered to be more efficient in depressing said gangue minerals than high molecular weight polysaccharides.

Low molecular weight polysaccharides may be obtained from higher molecular weight polysaccharides by reducing the molecular weight. Low molecular weight water soluble polysaccharide ethers may be obtained either by appropriately choosing the starting material for the preparation of the polysaccharide ether or they may be produced from higher molecular weight polysaccharides or polysaccharide ethers by reducing the molecular weight during or after their synthesis.

In the prior art, an aqueous hydrogen peroxide solution is generally used for reducing the molecular weight of polysaccharides and polysaccharide ethers. For example, U.S. Pat. No. 6,054,511 discloses a process for producing a high solids, low viscosity aqueous polysaccharide composition comprising stepwise or continuously reacting a polysaccharide or polysaccharide ether with hydrogen peroxide to produce aqueous compositions with a solids content of greater than 5 wt % and a viscosity at 25° C. of below 9,500 mPa·s. Preferably, a 30-50% aqueous hydrogen peroxide solution is used for the depolymerization of the polysaccharide or polysaccharide ether.

EP 0 136 722 discloses a process for preparing a carboxymethyl ethyl cellulose which is suitable for use in enteric coating. The process comprises depolymerizing carboxymethyl ethyl cellulose by dissolving carboxymethyl ethyl cellulose in an aqueous solution of a basic compound and adding a peroxide to the solution. After depolymerization, the resulting basic solution is neutralized with an acid. Preferable examples of the basic compound are ammonia, water-soluble amines, and alkali metal hydroxides. The preferred water soluble peroxide is hydrogen peroxide. The depolymerization is carried out in the presence of a basic compound in order to reduce the number of ester linkages, i.e. to reduce the degree of esterification.

A disadvantage of using hydrogen peroxide is that the depolymerization of the polysaccharide or polysaccharide ether takes several hours, typically about 4 to 7 hours in the examples of U.S. Pat. No. 6,054,511. In the examples of EP 0 136 722, depolymerization reaction times of about 5 to 6 hours are reported. A further drawback is that any remaining hydrogen peroxide must be destroyed before the polysaccharide or polysaccharide ether is recovered and this presents a safety problem. Also, the hydrogen peroxide is only available in the form of an aqueous solution and this presents a handling, storage, and transporting problem.

Another disadvantage of hydrogen peroxide is that its use does not always lead to a degree of depolymerization which is desired by the paper making industry, especially when the polysaccharide ether is manufactured in a so-called dry process.

U.S. Pat. No. 5,708,162 discloses a process for the preparation of a low molecular weight polysaccharide ether comprising initially introducing a relatively high molecular weight polysaccharide ether in suspension, e.g. a slurry, adding a perborate, and carrying out an oxidative degradation in an alkaline medium at a temperature of between 25° C. and 90° C. Typically, the polysaccharide ether starting materials, in particular cellulose ethers, are also prepared in suspension. The depolymerized polysaccharide ether product is isolated in a dry form.

A disadvantage of this process is that the depolymerization takes place in a suspension, typically using isopropanol or a mixture of isopropanol and water. The use of organic solvents such as isopropanol is not desirable and presents a waste and environmental problem. It also increases the volume of the starting material and final product and thus adds to the manufacturing, storage, and transporting costs. Furthermore, the low molecular weight polysaccharide ether suspension that is formed during the process of U.S. Pat. No. 5,708,162 in particular is not suitable for use in the paper making industry which requires aqueous solutions of low viscosity and having a high solids content. It is of course disadvantageous to first isolate and dry the depolymerized polysaccharide ether product and then dissolve it in water.

WO 01/07485 discloses a process for the depolymerization of polysaccharides or polysaccharide derivatives at increased temperatures comprising (i) mixing at least one polysaccharide with a predetermined amount of at least one peroxo compound and (ii) optionally reacting the polysaccharide of the mixture with a derivatization reagent in order to form a polysaccharide derivative. This document further discloses a mixture comprising at least one polysaccharide and at least one peroxo compound. It is mentioned that the disclosed process makes it possible to depolymerize polysaccharides in one step and to be able to simultaneously or subsequently produce derivatives having a desired degree of polymerization. Suitable polysaccharides are starch, cellulose, inulin, chitin, alginic acid, and guar gum. Suitable peroxo compounds are urea hydrogen peroxide (i.e. “Percarbamid” or carbamide peroxide), percarbonate, and perborate. All examples in this document relate to the preparation of low molecular weight cellulose carbamate using urea and urea hydrogen peroxide. The depolymerization or depolymerization/derivatization of the polysaccharide in accordance with the process of WO 01/07485 is carried out in a suspension of xylene and this presents several disadvantages as described hereinabove. Additionally, we found that the use of carbamide peroxide as such does not lead to the desired reduction in viscosity of the polymer within a reasonable period of time and thus also for this reason the technology described in this document is unsuitable for use commercially.

V. N. Kislenko and E. I. Kuryatnikov in the Russian Journal of General Chemistry, Vol. 70, 2000, pp. 1410-1412, describe the kinetics of degradation of water soluble cellulose ethers such as carboxymethyl cellulose, hydroxyethyl cellulose and methyl cellulose under the action of ammonium persulfate. This document does not disclose or suggest the process of the present invention.

The present invention provides a solution to the above-mentioned problems.

In accordance with the present invention there is provided a process for preparing a solution of a polysaccharide or polysaccharide ether having a viscosity of 1,000 mPa·s or less comprising adding to an aqueous medium a polysaccharide or polysaccharide ether and an alkaline depolymerization agent.

The present invention further relates to a solid composition comprising a polysaccharide ether and an alkaline depolymerization agent containing 0.25-15 mole equivalents of a base per mole of depolymerization agent.

Apart from avoiding the aforementioned drawbacks, the present invention provides the industry with a composition having the desired low viscosity and high solids content when dissolved in an aqueous medium. The invention process can be carried out in one step, within an acceptable time period, with nearly complete consumption of the depolymerization agent, and making use of readily available higher molecular weight polysaccharide ethers.

In the context of the present specification the term “aqueous medium” refers to a liquid medium essentially comprising water, in which depolymerized polysaccharide or polysaccharide ether resulting from the process of the invention dissolves completely. It is noted that other solvents can be used in addition to water as long as the resulting depolymerized polysaccharide or polysaccharide ether can be dissolved in the medium. It is most preferred to use only water without any other solvent, as water does not give environmental problems.

It is further noted that the term “solids content” refers to the weight percentage of dissolved compounds including polysaccharide or polysaccharide ether in the solution, based on the total weight of the solution. This content can be determined by measuring the weight of the solution and measuring the weight of the solids after removing the aqueous medium from the solution, e.g. by drying through heating at 140° C. until the weight of the solids is constant, and subsequently dividing the weight of the solids after drying and the weight of the solution multiplied by a hundred.

In accordance with the present invention, preferably an alkaline depolymerization agent containing 0.25-10, more preferably 0.25-5, even more preferably 0.5-2 mole equivalents of a base per mole of depolymerization agent, is used.

An alkaline depolymerization agent is generally in solid form at room temperature and is soluble in water at temperatures used in the process of the invention. The depolymerization agent may be alkaline in itself, such as sodium percarbonate which contains approximately 0.7 mole equivalents of sodium carbonate per mole of peroxide. The agent may also comprise a peroxo compound and an additional base. In such case, the alkaline depolymerization agent preferably contains 0.25-15 mole equivalents of a base per mole of peroxo compound.

Suitable examples of alkaline depolymerization agents and of peroxo compounds comprised therein have been described by N. Steiner and W. Eul on Peroxides and Peroxide Compounds, Inorganic Peroxides in Kirk-Othmer Encyclopedia of Chemical Technology, John Wiley & Sons, Inc. 2001 (online posting date of Jul. 13, 2001), in particular Chapter 3 on Group 13 (IIIB) peroxides, Chapter 6 on Group 16 (VIB) peroxides, and Chapter 8 on peroxohydrates, and by J. Sanchez and T. N. Myers on Peroxides and Peroxide Compounds, Organic Peroxides in Kirk-Othmer Encyclopedia of Chemical Technology, John Wiley & Sons, Inc. 1996 (online posting date of Dec. 4, 2000), in particular Chapter 6 on peroxyacids.

Suitable examples of alkaline depolymerization agents for use in accordance with the present invention include sodium percarbonate, sodium perborate, carbamide peroxide in combination with a base, sodium persulfate in combination with a base, 3-chloroperoxybenzoic acid (m-CPBA) in combination with a base, and mixtures thereof. Any base may be used in accordance with the present invention. Suitable examples include sodium hydroxide and sodium carbonate. A preferred base is sodium carbonate.

In accordance with the present invention, preferably sodium percarbonate, sodium perborate or sodium persulfate in combination with a base is used. Most preferably, sodium percarbonate or sodium persulfate in combination with a base is used.

In solutions having a content of solids below 15 wt %, sodium percarbonate is most preferred. Particularly suitable for solutions having a content of solids of 15 wt % or higher is sodium persulfate in combination with a base.

It is noted that other salts of the alkaline depolymerization agents, such as the potassium or ammonium salts, are suitable for use in the present invention as well.

The above-mentioned examples of suitable alkaline depolymerization agents that can be used in accordance with the present invention are commercially available and are relatively cheap materials. This has the advantage that solid mixtures of the polysaccharide or polysaccharide ether and the alkaline depolymerization agent can be prepared. Any desired final viscosity of the aqueous polysaccharide or polysaccharide ether solution can be obtained by determining the required amount of alkaline depolymerization agent in the solid composition using routine experimentation.

It was found that said solid compositions can be easily stored, transported, and handled. The depolymerization of the polymer can be initiated by addition of the solid composition of the polysaccharide ether and the alkaline depolymerization agent to water, typically tap water, and stirring the resulting mixture for an appropriate period of time, if desired at an elevated temperature. The polysaccharide ether and alkaline depolymerization agent can also be added separately to the water at the same time.

However, when the polysaccharide or polysaccharide ether is added to an aqueous solution of the alkaline depolymerization agent, the depolymerization agent may decompose before it is able to depolymerize the polymer and this reduces the efficiency of the depolymerization reaction. Preferably, therefore, the polysaccharide or polysaccharide ether and the alkaline depolymerization agent are added simultaneously to the water, either separately or in the form of a solid composition of the polysaccharide or polysaccharide ether and the alkaline depolymerization agent. The depolymerization of the polysaccharide or polysaccharide ether generally takes place after addition of the polymer and the alkaline depolymerization agent to the aqueous medium.

An advantage of the use of the solid composition comprising a polysaccharide ether and an alkaline depolymerization agent in accordance with the present invention is that the depolymerization of the polysaccharide ether can be carried out, for example, by a supplier of the paper making industry or by the paper making industry itself just before the low viscous, high solids aqueous solution is needed.

The depolymerization in accordance with the present invention can be carried out using conventional equipment, for example a stirred all glass or stainless steel reactor.

The invention process can be carried out over a wide temperature range—a practical range being 25 to 95° C.—typically by stirring at a selected temperature for a period of time until the final or desired viscosity is obtained. In the industry, pumps that are used for dosing chemicals such as carboxymethyl cellulose typically can handle viscosities up to 1,000 mPa·s (Brookfield LV rheometer, 25° C., 30 rpm). The optimum time, temperature, and stirring conditions can be determined by one of ordinary skill in the art using routine experimentation and the present specification and the Examples described below as guidelines. In the industry, aqueous solutions having viscosities generally of at least 1 mPa·s, preferably at least 10 mPa·s, more preferably at least 20 mPa·s and most preferably at least 50 mPa·s, and generally at most 1,000 mpa·s, preferably at most 800 mPa·s, more preferably at most 600 mPa·s and most preferably at most 400 mpa·s (Brookfield LV rheometer, 25° C., 30 rpm), are used.

It is advantageous to carry out the depolymerization in accordance with the present invention at an elevated temperature. Preferably, the temperature chosen is at least 35° C., more preferably at least 40° C., and at most 80° C., preferably at most 75° C., and most preferably at most 70° C.

The temperature may be changed or kept at the same level during the entire depolymerization process. For example, depending on the desired reaction conditions, the temperature may be initially relatively low and subsequently increased in order to maintain the same depolymerization rate during the whole process. However, in some depolymerization processes, the temperature of the solution increases without actively heating the solution. In those processes it may be desirable to actively keep the temperature at the same level.

The resulting aqueous solution that is obtained in accordance with the process of the present invention is ready for use in the industry and need not undergo any further treatment.

In accordance with the present invention, any polysaccharide or polysaccharide ether can be used. Suitable examples have been described as gums by J. N. BeMiller on Carbohydrates in Kirk-Othmer Encyclopedia of Chemical Technology, John Wiley & Sons, Inc. 1992 (online posting date of Dec. 4, 2000), in particular in Chapter 5. Either technical or purified grades of these polymers can be used.

Suitable examples of polysaccharides include guar gum, dextrin, xanthan gum, carrageenan, and gum arabic. Suitable examples of polysaccharide ethers include the carboxymethyl (CM), hydroxypropyl (HP), hydroxyethyl (HE), ethyl (E), methyl (M), hydrophobically modified (HM), quatemary ammonium (QN), and mixed ether derivatives of cellulose (C), guar (G), and starch (S), such as HEC, HPC, EHEC, CMHEC, HPHEC, MC, MHPC, MHEC, MEHEC, CMC, CMMC, CMG, HEG, HPG, CMHPG, HMCMC, HMHEC, HMHPC, HMEHEC, HMCMHEC, HMHPHEC, HMMC, HMMHPC, HMMHEC, HMCMMC, HMG, HMCMG, HMHEG, HMHPG, HMCMHPG, QNCMC, and HPS. These polysaccharides and polysaccharide ethers are known in the art and either are commercially available or can be manufactured using methods known per se in the art. The carboxymethyl derivatives generally are used in the form of an alkali metal salt, usually the sodium salt thereof.

Preferably, a polysaccharide ether is used in accordance with the present invention. Preferably, the polysaccharide ether is selected from the group consisting of CMC, HMCMC, HEC, HMHEC, EHEC, and HMEHEC. More preferably, the polysaccharide ether is CMC or carboxymethyl cellulose.

The molecular weight (MW) of the polysaccharide or polysaccharide ether to be used in accordance with the present invention can vary over a wide range. The molecular weight typically is in the range of 25,000 to 3,000,000, preferably 25,000 to 500,000, more preferably 50,000 to 250,000 Dalton.

The amount of polysaccharide or polysaccharide ether to be used in accordance with the present invention can vary over a wide range. It typically depends on the desired solids content of the resulting aqueous solution. Generally, the solids content of the solution is at least 1 wt %, preferably at least 2 wt %, and most preferably at least 5 wt %, and at most 40 wt %, preferably at most 30 wt %, and most preferably at most 25 wt % based on the total weight of the aqueous composition. In the paper industry, a solids content of preferably 5 to 15 wt %, more preferably 7 to 10 wt % is used.

The amount of alkaline depolymerization agent to be used in accordance with the present invention also can vary over a wide range and typically will be determined by the desired final viscosity of the polysaccharide or polysaccharide ether aqueous solution. A practical amount to be used is 0.1 to 30, preferably 0.5 to 15, more preferably 2 to 10 wt %, based on the weight of the polysaccharide or polysaccharide ether. The molecular weight of the depolymerized polysaccharide or polysaccharide ether typically is in the range of 10,000 to 250,000 Dalton.

It is known to the man skilled in the art that peroxide reactions can be catalyzed by impurities like transition metal ions ordinarily present in tap water. If necessary, such impurities may be added in a conventional amount to the invention process. Optionally, any of the known activators, which are mentioned for sodium perborate in U.S. Pat. No. 5,708,162, may be used in a conventional amount in the process of the present invention.

The depolymerization of the polysaccharide or polysaccharide ether can easily be followed by determining the viscosity of the aqueous solution. The amount of alkaline depolymerization agent in the reaction mixture can be determined as a function of the time in any conventional way. For example, the amount of peroxide can be determined by iodometric titration or by using peroxide test sticks, which are commercially available. The resulting aqueous solution containing the depolymerized polysaccharide or polysaccharide ether can be used either when the final or when the desired viscosity is reached. If a small amount of the alkaline depolymerization agent remains in the solution, the depolymerization agent may be neutralized by methods known to the man skilled in the art. Preferably, the alkaline depolymerization agent is reacted away completely rendering neutralization unnecessary. In this way, an aqueous solution is obtained which is safe and easy to handle.

The present invention is illustrated by the following Examples.

### EXAMPLE 1

In a stirred stainless steel reactor, 32.5 g of CMC (Akucell AF 0305, ex Akzo Nobel, having a water content of 7.6% and a viscosity of 4,757 mPa·s for a 6 wt % aqueous solution of said CMC when measured with a Brookfield LV rheometer operating at 10 rpm and 25° C.) were dissolved in 467.5 g of tap water at 65° C. giving a 6 wt % aqueous CMC solution. To this aqueous solution, 0.60 g of sodium percarbonate (ex Aldrich), i.e. 2 wt % relative to the amount of CMC, was added in one minute under vigorous stirring. Samples were taken after 0.25, 0.5 and 1 h of stirring. The viscosity (measured with a Brookfield LV rheometer operating at 30 rpm and 25° C.) of these samples was 297, 200 and 212 mPa·s, respectively. The percentage peroxide consumed was calculated after iodometric titration to be 96, 100 and 100%, respectively. The MW dropped from 132,000 Dalton at the start to 82,700 Dalton after 1 h of stirring.

### EXAMPLE 2

37.5 g of CMC (Akupure 0310, ex Akzo Nobel, having a water content of 8.8% and a viscosity of 2,843 mPa·s for a 6.9 wt % aqueous solution of said CMC when measured with a Brookfield LV rheometer operating at 10 rpm and 25° C.) was added in one minute to 462.5 g of tap water of 50° C. in a stirred all glass reactor. Then, 1.875 g of sodium percarbonate, i.e. 5 wt % relative to the amount of CMC, were added in one minute under vigorous stirring. Samples were taken after 0.25 and 0.5 h of stirring. The viscosity (measured with a Brookfield LV rheometer operating at 30 rpm and 25° C.) of these samples was 388 and 239 mpa·s, respectively. The percentage peroxide consumed was calculated after iodometric titration to be 78 and 95%, respectively. Upon depolymerization the MW dropped from 94,000 to 61,000 Dalton.

### EXAMPLE 3

A dry blend of 32.5 g of CMC (Akucell AF 0305, see Example 1) and 0.60 g of sodium percarbonate was made by mixing with a spatula. The blend was added under vigorous stirring in one minute to 467.5 g of tap water of 65° C. in a stainless steel reactor. Samples were taken after 0.25 and 0.5 h of stirring. The viscosity (measured with a Brookfield LV rheometer operating at 30 rpm and 25° C.) of these samples was 365 and 330 mPa·s, respectively. The percentage peroxide consumed was calculated after iodometric titration to be 99 and 100% respectively.

### EXAMPLE 4

Similar results as in Example 3 were obtained after complete consumption of the sodium percarbonate when the depolymerization was carried out at 55° C., 50° C. or 45° C. The lower the temperature, the slower the consumption of sodium percarbonate. Complete consumption of sodium percarbonate at the reaction temperature of 50° C. occurred after 0.5 h.

### EXAMPLE 5

A dry blend of 32.0 g of CMC (Akucell AF 0305, see Example 1, but containing 6.2% of water) and 0.88 g of sodium perborate (ex Aldrich) was made by mixing with a spatula. The blend was added under vigorous stirring in one minute to 468 g of tap water of 50° C. in an all glass reactor. Samples were taken after 0.25, 0.5, 1 and 2 h of stirring. The viscosity (measured with a Brookfield LV rheometer operating at 30 rpm and 25° C.) of these samples was 564, 369, 264 and 202 mpa·s, respectively. The percentage peroxide consumed was calculated after iodometric titration to be 58, 75, 90 and 98%, respectively.

### EXAMPLE 6

A dry blend of 40.0 g of a technical grade CMC (Gabrosa PA 386, having a water content of 5.8% and a viscosity of 7,049 mPa·s for a 7.5 wt % aqueous solution of said CMC when measured with a Brookfield LV rheometer operating at 1 rpm and 25° C.) and 0.80 g of sodium percarbonate was made by mixing with a spatula. The blend was added under vigorous stirring in one minute to 460.0 g of tap water of 67° C. in a stainless steel reactor. Samples were taken after 0.25 and 0.5 h of stirring. The viscosity (measured with a Brookfield LV rheometer operating at 30 rpm and 25° C.) of these samples was 251 and 233 mPa·s, respectively. The percentage peroxide consumed was determined by using peroxide test sticks (Quantofic® Peroxide 25) and was found to be 99 and 100%, respectively. A reduction in MW from 165,800 Dalton to 63,700 Dalton was observed.

### EXAMPLE 7

A dry blend of 32.0 g of CMC (Akucell AF 0305, see Example 1, but containing 6.2% of water), 1.37 g of sodium persulfate (ex Aldrich) and 0.40 gram of sodium carbonate (ex Aldrich) was made by mixing with a spatula. The blend was added under vigorous stirring in one minute to 468.0 g of tap water of 50° C. in a stirred all glass reactor. Samples were taken after 0.25, 0.5 and 1.0 h of stirring. The viscosity (measured with a Brookfield LV rheometer operating at 30 rpm and 25° C.) of these samples was 563, 178 and 63 mPa·s, respectively.

### COMPARATIVE EXAMPLE A

32.0 g of CMC (Akucell AF 0305, see Example 1, but containing 6.2% of water) was added in one minute to 468.0 g of tap water of 60° C. in a stirred all glass reactor. Immediately after the addition of the CMC, 1.40 g of 3-chloroperoxybenzoic acid (ex Akzo Nobel, 71% active content) was added in one minute under vigorous stirring. Samples were taken after 0.5, 1.0, and 2.0 h of stirring. The viscosity (measured with a Brookfield LV rheometer operating at 30 rpm and 25° C.) of these samples was 859, 592 and 388 mPa·s, respectively. The percentage peroxide consumed was calculated after iodometric titration to be 45, 64 and 80%, respectively.

### EXAMPLE 8

32.0 g of CMC (Akucell AF 0305, see Example 1, but containing 6.2% of water) was added in one minute to 468.0 g of tap water of 60° C. in a stirred all glass reactor. Immediately after the addition of the CMC, 1.40 g of 3-chloroperoxybenzoic acid (ex Akzo Nobel, 71% active content) and 0.40 g of sodium carbonate were added in one minute under vigorous stirring. Samples were taken after 0.25, 0.5 and 1.0 h of stirring. The viscosity (measured with a Brookfield LV rheometer operating at 30 rpm and 25° C.) of these samples was 495, 295 and 205 mPa·s, respectively. The percentage peroxide consumed was calculated after iodometric titration to be 78, 91 and 97%, respectively. Upon depolymerization a decrease in MW was observed from 126,400 to 80,500 Dalton.

Comparing the results of Comparative Example A and Example 8, the latter Example reveals a higher peroxide consumption and a lower viscosity in a shorter period of time, i.e. the reaction rate is faster.

### EXAMPLE 9

In a stirred all glass reactor, 32.2 g of EHEC (Bermocoll E270, ex Akzo Nobel, having a water content of 6.8% and a viscosity of 104,000 mpa·s for a 6 wt % aqueous solution of said EHEC when measured with a Brookfield LV rheometer operating at 0.5 rpm and 25° C.) were dissolved in 467.8 g of tap water at 50° C. giving a 6 wt % aqueous EHEC solution. To this aqueous solution, 1.50 g of sodium percarbonate (ex Aldrich), i.e. 5 wt % relative to the amount of EHEC, was added in one minute under vigorous stirring. Samples were taken after 0.5 and 1.0 h of stirring. The viscosity (measured with a Brookfield LV rheometer operating at 10 and 30 rpm, respectively, and 25° C.) of these samples was 2,693 and 1,128 mPa·s, respectively. The percentage peroxide consumed was calculated after iodometric titration to be 95 and 98%, respectively.

### EXAMPLE 10

In a stirred all glass reactor, 21.5 g of EHEC (Bermocoll E320G, ex Akzo Nobel, having a water content of 6.9% and a viscosity of 39,000 mPa·s for a 4 wt % aqueous solution of said EHEC when measured with a Brookfield LV rheometer operating at 1 rpm and 25° C.) were dissolved in 4787.5 g of tap water at 55° C. giving a 4 wt % aqueous EHEC solution. To this aqueous solution, 1.00 g of sodium percarbonate (ex Aldrich), i.e. 5 wt % relative to the amount of EHEC, was added in one minute under vigorous stirring. Samples were taken after 0.25, 0.5 and 1.0 h of stirring. The viscosity (measured with a Brookfield LV rheometer operating at 30 rpm and 25° C.) of these samples was 460, 329 and 267 mpa·s, respectively. The percentage peroxide consumed was calculated after iodometric titration to be 87, 97 and 99%, respectively. A decrease in MW was observed from 854,700 to 141,900 Dalton after 1.0 h of stirring.

### EXAMPLE 11

A dry blend of 11.2 g of guar gum (ex Dinesh Enterprises, having a water content of 10.3% and a viscosity of 350,000 mpa·s for a 2 wt % aqueous solution of said guar gum when measured with a Brookfield LV rheometer operating at 1 rpm and 20° C.) and 0.50 g of sodium percarbonate was made by mixing with a spatula. The blend was added under vigorous stirring in one minute to 488.9 g of tap water of 70° C. in a stirred all glass reactor. Samples were taken after 1.0 and 2.0 h of stirring. The viscosity (measured with a Brookfield LV rheometer operating at 30 rpm and 25° C.) of these samples was 301 and 158 mpa·s, respectively. The percentage peroxide consumed was calculated after iodometric titration to be 80 and 95%, respectively. Upon depolymerization a decrease in MW was observed from 1,914,000 to 180,200 Dalton.

### EXAMPLE 12

A dry blend of 75.0 g of CMC (Akucell AF 0310, see Example 2), 7.50 g of sodium persulfate (ex Aldrich) and 7.50 gram of sodium carbonate (ex Aldrich) was made by mixing with a spatula. The blend was added under vigorous stirring in 5 minutes to 425.0 g of tap water of 50° C. in a stirred all glass reactor to obtain a 15% (w/w) solution of CMC.

Samples were taken after 0.5, 2 and 4 and 5 h of stirring. The viscosity (measured with a Brookfield LV rheometer operating at 30 rpm and 25° C.) of these samples was 650, 69, 39 and 33 mpa·s, respectively. According to iodometric titration all persulfate was consumed after 5 hours.

### EXAMPLE 13

A dry blend of 125 g of CMC (Gabrosa PA 186), 12.5 g of sodium persulfate (ex Aldrich) and 12.5 gram of sodium carbonate (ex Aldrich) was made by mixing with a spatula. The blend was added under vigorous stirring in 5 minutes to 375.0 g of tap water of 50° C. in a stirred all glass reactor to obtain a 25% (w/w) solution of CMC.

Within 1 hour the viscosity dropped below 1000 mPa·s. According to iodometric titration all persulfate was consumed after 4 hours. The solution showed thixotropic behavior. The viscosity after 4 h (measured with a Brookfield LV rheometer operating at 30 rpm and 25° C.) of a well sheared sample was 625 mpa·s.

1. A process for preparing a solution of a polysaccharide or polysaccharide ether having a viscosity of 1,000 mPa·s or less comprising adding to an aqueous medium a polysaccharide or polysaccharide ether and an alkaline depolymerization agent, characterized in that the polysaccharide or polysaccharide ether and the alkaline depolymerization agent are added simultaneously to the aqueous medium.

2. A process according to claim 1, characterized in that a solid composition comprising the polysaccharide or polysaccharide ether and the alkaline depolymerization agent is added to the aqueous medium.

3. A process according to claim 1, characterized in that the alkaline depolymerization agent is selected from the group consisting of sodium percarbonate, sodium perborate, carbamide peroxide in combination with a base, sodium persulfate in combination with a base, 3-chloroperoxybenzoic acid (m-CPBA) in combination with a base, and mixtures thereof.

4. A process according to claim 1, characterized in that the base is sodium hydroxide or sodium carbonate.

5. A process according to claim 3, characterized in that the alkaline depolymerization agent is sodium percarbonate, sodium perborate or sodium persulfate in combination with a base.

6. A process according to claim 1, characterized in that the polysaccharide ether is selected from the group consisting of carboxymethyl cellulose, hydrophobically modified carboxymethyl cellulose, hydroxyethyl cellulose, hydrophobically modified hydroxyethyl cellulose, ethyl hydroxyethyl cellulose, and hydrophobically modified ethyl hydroxyethyl cellulose.

7. A solid composition comprising a polysaccharide ether and an alkaline depolymerization agent characterized in that the alkaline depolymerization agent is selected from the group consisting of sodium percarbonate, carbamide peroxide in combination with a base, sodium persulfate in combination with a base, 3-chloroperoxybenzoic acid (m-CPBA) in combination with a base, and mixtures thereof.

8. A composition according to claim 7, characterized in that the depolymerization agent is sodium percarbonate, or sodium persulfate in combination with a base.

9. A composition according to claim 7, characterized in that the polysaccharide ether is selected from the group consisting of carboxymethyl cellulose, hydrophobically modified carboxymethyl cellulose, hydroxyethyl cellulose, hydrophobically modified hydroxyethyl cellulose, ethyl hydroxyethyl cellulose, and hydrophobically modified ethyl hydroxyethyl cellulose.

10. A composition according to claim 7 comprising carboxymethyl cellulose and sodium percarbonate.

11. A composition according to claim 8, characterized in that the polysaccharide ether is selected from the group consisting of carboxymethyl cellulose, hydrophobically modified carboxymethyl cellulose, hydroxyethyl cellulose, hydrophobically modified hydroxyethyl cellulose, ethyl hydroxyethyl cellulose, and hydrophobically modified ethyl hydroxyethyl cellulose.

12. A composition according to claim 8 comprising carboxymethyl cellulose and sodium percarbonate.
